(19) United States
(12) Patent Application Publication
(10) Pub. No.: US 2006/0073057 A1
(43) Pub. Date: Apr. 6, 2006

(54) Variable capacity type orbiting vane compressor

(75) Inventors: Dong-won Yoo, Seoul (KR); Hyeong-kook Lee, Gunpo-Si (KR); Seon-woong Hwang, Anyang-Si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/111,863

(22) Filed: Apr. 22, 2005

(30) Foreign Application Priority Data
Oct. 6, 2004 (KR) 10-2004-0079607

(51) Int. Cl. F01C 20/18; F03C 4/00; F16N 13/20; F01C 1/02

(52) U.S. Cl. 418/59; 418/62; 418/30; 418/29

(57) ABSTRACT

Disclosed herein is a variable capacity type orbiting vane compressor that is capable of more easily changing a ratio in volume of an inner compression chamber to an outer compression chamber, the inner and outer compression chambers being formed in a cylinder through an orbiting movement of an orbiting vane, whereby capacity of the orbiting vane compressor is easily and conveniently changed. The thickness of a vane plate at any one of the inside and the outside of a circular vane formed at the upper part of the orbiting vane is larger than that of the vane plate at the other of the inside and the outside of the circular vane to change a ratio in volume of the inner compression chamber to the outer compression chamber in the cylinder.

### BACKGROUND OF THE INVENTION

1. Field of the Invention

The present invention relates to an orbiting vane compressor, and, more particularly, to a variable capacity type orbiting vane compressor that is capable of more easily changing a ratio in volume of an inner compression chamber to an outer compression chamber, the inner and outer compression chambers being formed in a cylinder through an orbiting movement of an orbiting vane, whereby capacity of the orbiting vane compressor is easily and conveniently changed, and therefore, the orbiting vane compressor is operated with various capacities.

2. Description of the Related Art

Referring to FIG. 1, there is illustrated a conventional hermetically sealed type orbiting vane compressor. As shown in FIG. 1, a drive unit D and a compression unit P are mounted in a shell 1 while the drive unit D and the compression unit P are hermetically sealed. The drive unit D and the compression unit P are connected to each other via a vertical crankshaft 8, the upper and lower ends of which are rotatably supported by a main frame 6 and a subsidiary frame 7, such that power from the drive unit D is transmitted to the compression unit P through the crankshaft 8.

The drive unit D comprises: a stator 2 fixedly disposed between the main frame 6 and the subsidiary frame 7; and a rotor 3 disposed in the stator 2 for rotating the crankshaft 8, which vertically extends through the rotor 3, when electric current is supplied to the rotor 3. The rotor 3 is provided at the top and bottom parts thereof with balance weights 3a, which are disposed symmetrically to each other for preventing the crankshaft 8 from being rotated in an unbalanced state due to a crank pin 81.

The compression unit P comprises an orbiting vane 5 having a boss 55 formed at the lower part thereof. The crank pin 81 is fixedly fitted in the boss 55 of the orbiting vane 5. As the orbiting vane 5 performs an orbiting movement in a cylinder 4, refrigerant gas introduced into the cylinder 4 through an inlet tube 11 is compressed. The cylinder 4 comprises an inner ring 41 integrally formed at the upper part thereof while being protruded downward. The orbiting vane 5 comprises a circular vane 51 formed at the upper part thereof while being protruded upward. The circular vane 51 performs an orbiting movement in an annular space 42 defined between the inner ring 41 and the inner wall of the cylinder 4. Through the orbiting movement of the circular vane 51, inner and outer compression chambers are formed at the inside and the outside of the circular vane 51, respectively. Refrigerant gases compressed in the inner and outer compression chambers are discharged out of the cylinder 4 through inner and outer outlet ports 44 and 44a formed at the upper part of the cylinder 4, respectively.

Between the main frame 6 and the orbiting vane 5 is disposed an Oldham's ring 9 for preventing rotation of the orbiting vane 5. Through the crankshaft 8 is longitudinally formed an oil supplying channel 82 for allowing oil to be supplied to the compression unit P therethrough when an oil pump 83 mounted at the lower end of the crankshaft 8 is operated.

The illustrated conventional orbiting vane compressor is a low-pressure orbiting vane compressor wherein refrigerant gas compressed by the compression unit P is discharged to a high-pressure chamber 12 formed at the upper part of the shell 1 through the inner and outer outlet ports 44 and 44a of the cylinder 4. An outlet tube 13, which penetrates the shell 1, communicates with the high-pressure chamber 12. The inlet tube 11 is disposed below the outlet tube 13. Specifically, the inlet tube 11 penetrates the shell 1 such that the inlet tube 11 communicates with one side of the main frame 6.

When electric current is supplied to the drive unit D, the rotor 3 of the drive unit D is rotated, and therefore, the crankshaft 8 is also rotated. As the crankshaft 8 is rotated, the orbiting vane 5 of the compression unit P performs an orbiting movement along a radius of the orbiting movement while the crank pin 81 of the crankshaft 8 is eccentrically fitted in the boss 55 formed at the lower part of the orbiting vane 5.

As a result, the circular vane 51 of the orbiting vane 5, which is inserted in the annular space 42 defined between the inner ring 41 and the inner wall of the cylinder 4, also performs an orbiting movement to compress refrigerant gas introduced into the annular space 42. At this time, the inner and outer compression chambers are formed at the inside and the outside of the circular vane 51 in the annular space 41, respectively. Refrigerant gases compressed in the inner and outer compression chambers are guided to the high-pressure chamber 12 through the inner and outer outlet ports 44 and 44a formed at the upper part of the cylinder 4, which communicate with the inner and outer compression chambers, respectively, and are then discharged out of the orbiting vane compressor through the outlet tube 13. In this way, high-temperature and high-pressure refrigerant gas is discharged.

FIG. 2 is an exploded perspective view illustrating the structure of the compression unit P shown in FIG. 1.

In the compression unit P of the orbiting vane compressor, as shown in FIG. 2, the orbiting vane 5, which is connected to the crankshaft 8, is disposed on the upper end of the main frame 6, which rotatably supports the upper part of the crankshaft 8. The cylinder 4, which is attached to the main frame 6, is disposed above the orbiting vane 5. The cylinder 4 is provided at a predetermined position of the circumferential part thereof with an inlet port 43. The inner and outer outlet ports 44 and 44a are formed at predetermined positions of the upper end of the cylinder 4.

The crank pin 81 of the crankshaft 8 is fixedly fitted in the boss 55 of the orbiting vane 5. At a predetermined position of the circumferential part of the circular vane 51 of the orbiting vane 5 is formed a through-hole 52 for allowing refrigerant gas introduced through the inlet port 43 of the cylinder 4 to be guided into the circular vane 51 therethrough. At another predetermined position of the circumferential part of the circular vane 51 of the orbiting vane 5, which is adjacent to the position where the through-hole 52 is disposed, is formed an opening 53. A slider 54 is slidably disposed in the opening 53.

FIG. 3 is a cross-sectional view illustrating the operation of the conventional orbiting vane compressor shown in FIG. 1. When the orbiting vane 5 of the compression unit P is driven by power transmitted to the compression unit P from the drive unit D through the crankshaft 8, as shown in FIG. 3, the circular vane 51 of the orbiting vane 5 disposed in the annular space 42 of the cylinder 4 performs an orbiting movement in the annular space 42 of the cylinder 4, as indicated by arrows, to compress refrigerant gas introduced into the annular space 42 through the inlet port 43.

At the initial orbiting position of the orbiting vane 5 of the compression unit P (i.e., the O-degree orbiting position), refrigerant gas is introduced into an inner suction chamber A1 through the inlet port 43 and the through-hole 52 of the circular vane 51, and compression is performed in an outer compression chamber B2 of the circular vane 51 while the outer compression chamber B2 does not communicate with the inlet port 43 and the outer outlet port 44a. Refrigerant gas is compressed in an inner compression chamber A2, and at the same time, the compressed refrigerant gas is discharged out of the inner compression chamber A2 through the inner outlet port 44.

At the 90-degree orbiting position of the orbiting vane 5 of the compression unit P, the compression is still performed in the outer compression chamber B2 of the circular vane 51, and almost all the compressed refrigerant gas is discharged out of the inner compression chamber A2 through the inner outlet port 44. At this stage, an outer suction chamber B1 appears so that refrigerant gas is introduced into the outer suction chamber B1 through the inlet port 43.

At the 180-degree orbiting position of the orbiting vane 5 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 44a. Consequently, compressed refrigerant gas is discharged out of the outer compression chamber B2 through the outer outlet port 44a.

At the 270-degree orbiting position of the orbiting vane 5 of the compression unit P, almost all the compressed refrigerant gas is discharged out of the outer compression chamber B2 of the circular vane 51 through the outer outlet port 44a, and the compression is still performed in the inner compression chamber A2 of the circular vane 51. Also, compression is newly performed in the outer suction chamber B1. When the orbiting vane 5 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the orbiting vane 5 of the compression unit P is returned to the position where the orbiting movement of the orbiting vane 5 is initiated. In this way, a 360-degree-per-cycle orbiting movement of the orbiting vane 5 of the compression unit P is accomplished. The orbiting movement of the orbiting vane 5 of the compression unit P is repeatedly performed in succession.

The slider 54 is slidably disposed in the opening 53 for maintaining the seal between the inner and outer compression chambers A2 and B2 of the circular vane 51.

The inner and outer compression chambers A2 and B2 formed in the cylinder by the above-described orbiting movement of the orbiting vane 5 are designed such that a ratio in volume of the inner compression chamber A2 to the outer compression chamber B2 is generally 40:60 or 30:70. This volume ratio may be changed by changing the thickness of the circular vane 51 formed at the upper part of the orbiting vane 5.

Alternatively, the ratio in volume of the inner compression chamber A2 to the outer compression chamber B2 may be changed by changing the diameter of the annular space 42 defined in the cylinder 4. However, it is very difficult to vary the ratio in volume of the inner compression chamber A2 to the outer compression chamber B2 by either changing the thickness of the circular vane 51 or changing the diameter of the annular space 42, and therefore, change of the volume ratio is performed with limits. In conclusion, it is not easy to vary the capacity of the orbiting vane compressor.

### SUMMARY OF THE INVENTION

Therefore, the present invention has been made in view of the above problems, and it is an object of the present invention to provide a variable capacity type orbiting vane compressor that is capable of more easily changing a ratio in volume of an inner compression chamber to an outer compression chamber, the inner and outer compression chambers being formed in a cylinder through an orbiting movement of an orbiting vane, whereby capacity of the orbiting vane compressor is easily and conveniently changed, and therefore, the orbiting vane compressor is operated with various capacities.

In accordance with the present invention, the above and other objects can be accomplished by the provision of a variable capacity type orbiting vane compressor comprising: a hermetically sealed shell having an inlet tube and an outlet tube; a crankshaft having upper and lower ends supported in the shell, the crankshaft being rotated by a drive unit; and inner and outer compression chambers formed in the cylinder, the inner and outer compression chambers being isolated from each other by a circular vane of an orbiting vane, which is connected to the crankshaft, wherein the thickness of a vane plate at any one of the inside and the outside of the circular vane is larger than that of the vane plate at the other of the inside and the outside of the circular vane to change a ratio in volume of the inner compression chamber to the outer compression chamber in the cylinder.

Preferably, the circular vane is formed at the upper part of the vane plate, and the orbiting vane further comprises: a boss formed at a lower part of the vane plate, the boss being mounted to the crankshaft.

Preferably, the boss is formed at the vane plate inside the circular vane while being protruded upward.

Preferably, the crankshaft has an oil supplying channel formed longitudinally therethrough.

Preferably, the thickness of the vane plate at the inside of the circular vane is larger than that of the vane plate at the outside of the circular vane.

Preferably, the thickness of the vane plate at the outside of the circular vane is larger than that of the vane plate at the inside of the circular vane.

Preferably, the circular vane is provided at a predetermined position of the circumferential part thereof with an opening, and the orbiting vane further comprises: a slider disposed in the opening.

Preferably, the circular vane is provided at another predetermined position of the circumferential part thereof, adjacent to the position where the slider is disposed, with a through-hole for allowing refrigerant gas to be introduced into the circular vane therethrough.

Preferably, the cylinder is provided at a predetermined position of the circumferential part thereof with an inlet port, which communicates with the through-hole of the circular vane.

Preferably, the cylinder is provided at the upper part thereof with a pair of inner and outer outlet ports, which communicate with the inner and outer compression chambers, respectively.

Preferably, the variable capacity type orbiting vane compressor further comprises: a separating plate disposed between the outer circumferential part of the cylinder and the inner circumferential part of the shell such that refrigerant gas discharged through the outlet port provided at the upper part of the cylinder is guided into the outlet tube through the high-pressure chamber disposed above the cylinder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the overall structure of a conventional orbiting vane compressor;

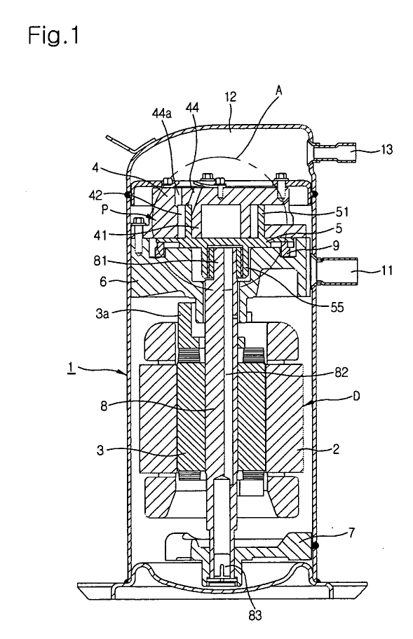

FIG. 2 is an exploded perspective view illustrating the structure of a compression unit of the conventional orbiting vane compressor shown in FIG. 1;

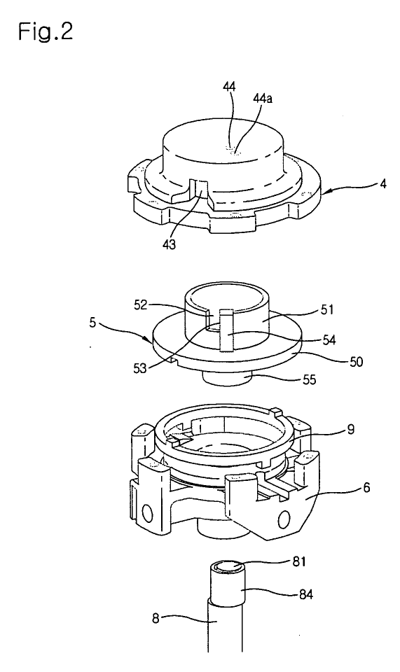

FIG. 3 is a cross-sectional view illustrating the operation of the conventional orbiting vane compressor shown in FIG. 1;

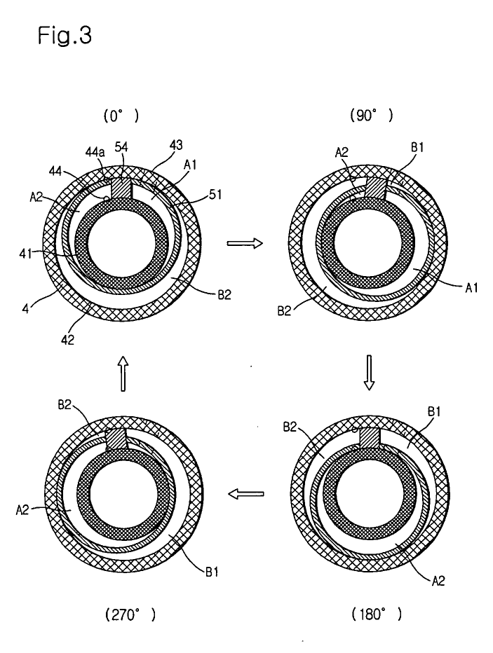

FIG. 4 is a longitudinal sectional view illustrating the overall structure of a variable capacity type orbiting vane compressor according to a first preferred embodiment of the present invention;

FIG. 5 is a partially enlarged view of the variable capacity type orbiting vane compressor according to the first preferred embodiment of the present invention shown in FIG. 4;

FIG. 6 is a longitudinal sectional view illustrating the overall structure of a variable capacity type orbiting vane compressor according to a second preferred embodiment of the present invention; and

FIG. 7 is a partially enlarged view of the variable capacity type orbiting vane compressor according to the second preferred embodiment of the present invention shown in FIG. 6.

### DESCRIPTION OF THE PREFERRED EMBODIMENTS

Now, preferred embodiments of the present invention will be described in detail with reference to the accompanying drawings.

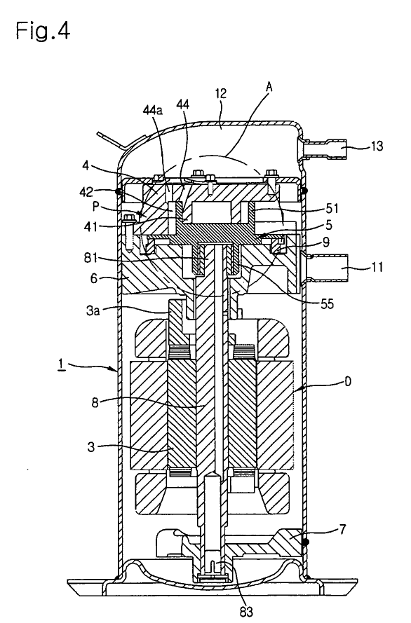

FIG. 4 is a longitudinal sectional view illustrating the overall structure of a variable capacity type orbiting vane compressor according to a first preferred embodiment of the present invention.

As shown in FIG. 4, the variable capacity type orbiting vane compressor comprises: a hermetically sealed shell 1 having an inlet tube 11 connected in communication to a predetermined position of the shell 1 and an outlet tube 13 connected in communication to another predetermined position of the shell 1. At the center in the shell 1 is vertically disposed a crankshaft 8. The upper and lower ends of the crankshaft 8 are supported by a main frame 6 and a subsidiary frame 7, respectively.

Between the main frame 6 and the subsidiary frame 7 is disposed a drive unit D, which comprises a stator 2 and a rotor 3. When electric current is supplied to the drive unit D, the rotor 3 is rotated. As the rotor 3 is rotated, the crankshaft 8 is also rotated. Above the drive unit D is disposed a compression unit P for receiving power from the drive unit D through the crankshaft 8 to perform a compression operation.

The compression unit P comprises an orbiting vane 5 eccentrically attached to the upper end of the crankshaft 8, while the orbiting vane 5 is prevented from rotating, for performing an orbiting movement in an annular space 42 defined in a cylinder 4 disposed at the upper part of the shell 1 as the crankshaft 8 is rotated. Refrigerant gas introduced into the cylinder 4 is compressed by the orbiting movement of the orbiting vane 5.

The orbiting vane 5 comprises: a circular vane 51 integrally formed at the upper part of a vane plate 50 of the orbiting vane 5 while being protruded upward; and a boss 55 integrally formed at the lower part of the vane plate 50 while being protruded downward.

In the illustrated first embodiment of the present invention, the thickness of the vane plate 50 inside the circular vane 51 is increased, and the length of an inner ring 41 disposed at the upper part of the cylinder 4 is decreased as much as the increased thickness of the vane plate 50, so as to reduce the volume of an inner compression chamber A2 formed between the inner ring 41 of the cylinder 4 and the circular vane 51. As a result, a ratio in volume of the inner compression chamber A2 to an outer compression chamber B2 of the circular vane 51 is changed, and therefore, total capacity of the orbiting vane compressor is changed.

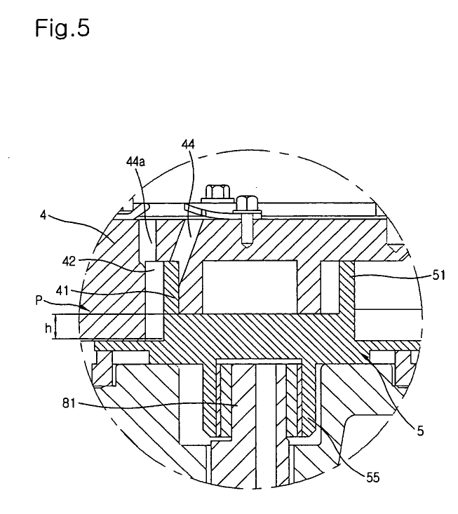

A more detailed description will be given of the change of the ratio in volume of the inner compression chamber A2 to the outer compression chamber B2 of the circular vane 51 with reference to FIG. 5. In the conventional orbiting vane compressor, the height of the vane plate 50 inside the circular vane 51 is the same as that of the van plate 50 outside the circular vane 51. In the orbiting vane compressor according to the first preferred embodiment of the present invention, the thickness of the vane plate 50 inside the circular vane 51 is increased, and therefore, the vane plate 50 inside the circular vane 51 has an increased height (h) corresponding the increased thickness. As a result, the volume of the inner compression chamber A2 formed between the inner ring 41 of the cylinder 4, the length of which is decreased as much as the increased height (h), and the circular vane 51 is reduced. In this case, a ratio in volume of the outer compression chamber B2 formed between the circular vane 51 and the inner wall of the cylinder 4 to the inner compression chamber A2 is increased, although total compression capacity of the orbiting vane compressor is decreased.

In the illustrated first embodiment of the present invention, the thickness of the vane plate 50 inside the circular vane 51 is increased to change the thickness of the vane plate 50 of the orbiting vane 5. Alternatively, the thickness of the vane plate 50 outside the circular vane 51 may be increased to change the thickness of the vane plate 50 of the orbiting vane 5. In this case, the length of the inner ring 41 of the cylinder 4 is not decreased. As a result, the outer compression chamber B2 formed between the circular vane 51 and the inner wall of the cylinder 4 is decreased corresponding to the increased thickness of the vane plate 50 outside the circular vane 51. Consequently, a ratio in volume of the outer compression chamber B2 formed between the circular vane 51 and the inner wall of the cylinder 4 to the inner compression chamber A2 is changed, and total compression capacity of the orbiting vane compressor is also changed.

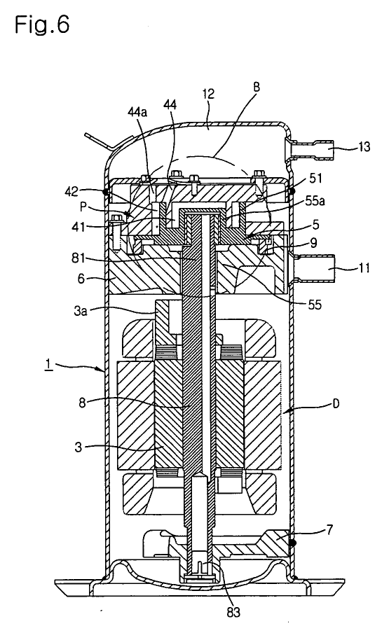

FIG. 6 is a longitudinal sectional view illustrating the overall structure of a variable capacity type orbiting vane compressor according to a second preferred embodiment of the present invention.

The variable capacity type orbiting vane compressor according to the second preferred embodiment of the present invention is identical in construction and operation to the variable capacity type orbiting vane compressor according to the previously described first preferred embodiment of the present invention except for the structure of the orbiting vane 5.

Specifically, the orbiting vane 5 further comprises a top boss 55a formed at the upper part of the vane plate 50 while being protruded upward. The top boss 55a of the orbiting vane 5 is disposed inside of the circular vane 51, which is integrally formed at the upper part of the vane plate 50 while being protruded upward. When refrigerant gas is compressed in the cylinder 4 according to the orbiting movement of the orbiting vane 5, overturning moment is generated. The orbiting vane 5 according to the illustrated embodiment of the present invention has an advantage in that the orbiting vane 5 is prevented from being inclined to one side.

In the illustrated second embodiment of the present invention, the thickness of the vane plate 50 inside the circular vane 51 between the circular vane 51 and the top boss 55a is increased, and the length of the inner ring 41 disposed at the upper part of the cylinder 4 is decreased as much as the increased thickness of the vane plate 50, so as to reduce the volume of the inner compression chamber A2 formed between the inner ring 41 of the cylinder 4 and the circular vane 51. As a result, a ratio in volume of the inner compression chamber A2 to an outer compression chamber B2 of the circular vane 51 is changed, and therefore, total capacity of the orbiting vane compressor is changed.

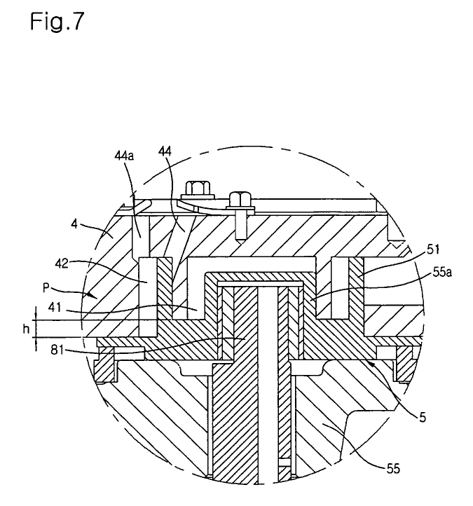

A more detailed description will be given of the change of the ratio in volume of the inner compression chamber A2 to the outer compression chamber B2 of the circular vane 51 with reference to FIG. 7. In the conventional orbiting vane compressor, the height of the vane plate 50 inside the circular vane 51 between the circular vane 51 and the top boss 55a is the same as that of the vane plate 50 outside the circular vane 51. In the orbiting vane compressor according to the second preferred embodiment of the present invention, the thickness of the vane plate 50 inside the circular vane 51 between the circular vane 51 and the top boss 55a is increased, and therefore, the vane plate 50 inside the circular vane 51 between the circular vane 51 and the top boss 55a has an increased height (h) corresponding the increased thickness. As a result, the volume of the inner compression chamber A2 formed between the inner ring 41 of the cylinder 4, the length of which is decreased as much as the increased height (h), and the circular vane 51 is reduced. In this case, a ratio in volume of the outer compression chamber B2 formed between the circular vane 51 and the inner wall of the cylinder 4 to the inner compression chamber A2 is increased, although total compression capacity of the orbiting vane compressor is decreased.

In the illustrated second embodiment of the present invention, the thickness of the vane plate 50 inside the circular vane 51 between the circular vane 51 and the top boss 55a is increased to change the thickness of the vane plate 50 of the orbiting vane 5. Alternatively, the thickness of the vane plate 50 outside the circular vane 51 may be increased to change the thickness of the vane plate 50 of the orbiting vane 5. In this case, the length of the inner ring 41 of the cylinder 4 is not decreased. As a result, the outer compression chamber B2 formed between the circular vane 51 and the inner wall of the cylinder 4 is decreased corresponding to the increased thickness of the vane plate 50 outside the circular vane 51. Consequently, a ratio in volume of the outer compression chamber B2 formed between the circular vane 51 and the inner wall of the cylinder 4 to the inner compression chamber A2 is changed, and total compression capacity of the orbiting vane compressor is also changed.

As apparent from the above description, the present invention provides a variable capacity type orbiting vane compressor that is capable of more easily changing a ratio in volume of an inner compression chamber to an outer compression chamber, the inner and outer compression chamber being formed in a cylinder through an orbiting movement of an orbiting vane, by changing the thickness of a vane plate inside or outside a circular vane of the orbiting vane. Consequently, the present invention has the effect of changing a ratio in volume of the outer compression chamber to the inner compression chamber, easily and conveniently changing capacity of the orbiting vane compressor, and operating the orbiting vane compressor with various capacities.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An orbiting vane comprising:
a circular vane formed at the upper part of a vane plate; and
a boss formed at the lower part of the vane plate, wherein
the thickness of the vane plate at any one of the inside and the outside of the circular vane is larger than that of the vane plate at the other of the inside and the outside of the circular vane.

2. The vane as set forth in claim 1, wherein the boss is formed at the vane plate inside the circular vane while being protruded outward.

3. The vane as set forth in claim 1, wherein the thickness of the vane plate at the inside of the circular vane is larger than that of the vane plate at the outside of the circular vane.

4. The vane as set forth in claim 1, wherein the thickness of the vane plate at the outside of the circular vane is larger than that of the vane plate at the inside of the circular vane.

5. The vane as set forth in claim 1, wherein the circular vane is provided at a predetermined position of the circumferential part thereof with an opening, and the orbiting vane further comprises: a slider disposed in the opening.

6. The vane as set forth in claim 5, wherein the circular vane is provided at another predetermined position of the circumferential part thereof, adjacent to the position where the slider is disposed, with a through-hole for allowing refrigerant gas to be introduced into the circular vane therethrough.

7. A compression unit of an orbiting vane compressor having an orbiting vane comprising a circular vane for dividing an annular space defined in a cylinder into inner and outer compression chambers to compress refrigerant gas, wherein
the thickness of a vane plate at any one of the inside and the outside of the circular vane is larger than that of the vane plate at the other of the inside and the outside of the circular vane to change a ratio in volume of the inner compression chamber to the outer compression chamber in the cylinder.

8. The unit as set forth in claim 7, wherein
the circular vane is formed at the upper part of the vane plate, and
the orbiting vane further comprises: a boss formed at a lower part of the vane plate, the boss being mounted to a crankshaft.

9. The unit as set forth in claim 8, wherein the boss is formed at the vane plate inside the circular vane while being protruded outward.

10. The unit as set forth in claim 7, wherein the thickness of the vane plate at the inside of the circular vane is larger than that of the vane plate at the outside of the circular vane.

11. The unit as set forth in claim 7, wherein the thickness of the vane plate at the outside of the circular vane is larger than that of the vane plate at the inside of the circular vane.

12. The unit as set forth in claim 7, wherein the circular vane is provided at a predetermined position of the circumferential part thereof with an opening, and the orbiting vane further comprises: a slider disposed in the opening.

13. The unit as set forth in claim 12, wherein the circular vane is provided at another predetermined position of the circumferential part thereof, adjacent to the position where the slider is disposed, with a through-hole for allowing refrigerant gas to be introduced into the circular vane therethrough.

14. The unit as set forth in claim 13, wherein the cylinder is provided at a predetermined position of the circumferential part thereof with an inlet port, which communicates with the through-hole of the circular vane.

15. The unit as set forth in claim 7, wherein the annular space is defined between the inner wall of the cylinder and an inner ring disposed in the cylinder.

16. The unit as set forth in claim 7, wherein the cylinder is provided at the upper part thereof with a pair of inner and outer outlet ports, which communicate with the inner and outer compression chambers, respectively.

17. A variable capacity type orbiting vane compressor comprising:
a hermetically sealed shell having an inlet tube and an outlet tube;
a crankshaft having upper and lower ends supported in the shell, the crankshaft being rotated by a drive unit; and
inner and outer compression chambers formed in the cylinder, the inner and outer compression chambers being isolated from each other by a circular vane of an orbiting vane, which is connected to the crankshaft, wherein
the thickness of a vane plate at any one of the inside and the outside of the circular vane is larger than that of the vane plate at the other of the inside and the outside of the circular vane to change a ratio in volume of the inner compression chamber to the outer compression chamber in the cylinder.

18. The compressor as set forth in claim 17, wherein
the circular vane is formed at the upper part of the vane plate, and
the orbiting vane further comprises: a boss formed at a lower part of the vane plate, the boss being mounted to the crankshaft.

19. The compressor as set forth in claim 18, wherein the boss is formed at the vane plate inside the circular vane while being protruded outward.

20. The compressor as set forth in claim 18, wherein the crankshaft has an oil supplying channel formed longitudinally therethrough.

21. The compressor as set forth in claim 17, wherein the thickness of the vane plate at the inside of the circular vane is larger than that of the vane plate at the outside of the circular vane.

22. The compressor as set forth in claim 17, wherein the thickness of the vane plate at the outside of the circular vane is larger than that of the vane plate at the inside of the circular vane.

23. The compressor as set forth in claim 17, wherein
the circular vane is provided at a predetermined position of the circumferential part thereof with an opening, and
the orbiting vane further comprises: a slider disposed in the opening.

24. The compressor as set forth in claim 23, wherein the circular vane is provided at another predetermined position of the circumferential part thereof, adjacent to the position where the slider is disposed, with a through-hole for allowing refrigerant gas to be introduced into the circular vane therethrough.

25. The compressor as set forth in claim 24, wherein the cylinder is provided at a predetermined position of the circumferential part thereof with an inlet port, which communicates with the through-hole of the circular vane.

26. The compressor as set forth in claim 17, wherein the cylinder is provided at the upper part thereof with a pair of inner and outer outlet ports, which communicate with the inner and outer compression chambers, respectively.

27. The compressor as set forth in claim 26, further comprising:
a separating plate disposed between the outer circumferential part of the cylinder and the inner circumferential part of the shell such that refrigerant gas discharged through the outlet port provided at the upper part of the cylinder is guided into the outlet tube through the high-pressure chamber disposed above the cylinder.
